(19) United States
(12) Patent Application Publication
(10) Pub. No.: US 2007/0152355 A1
(43) Pub. Date: Jul. 5, 2007

(54) Cylindrical insert fluid injector / vacuum pump

(76) Inventor: John Dow Hartley, Houston, TX (US)

Correspondence Address: John D. Hartley, Jr., 16507 Amcreek Rd., Houston, TX, 77068, US

(21) Appl. No.: 11/324,068

(22) Filed: Dec. 30, 2005

(51) Int. Cl. B01F 3/04; F02M 19/08

(52) U.S. Cl. 261/76; 261/DIG. 12

(57) ABSTRACT

A method of producing a hydrodynamic cavitation fluid injector, hydrodynamic vacuum pump, venturi fluid injector, or similar device in which a special cylindrical insert is combined with a suitable body, such as one of any number of common off-the-shelf or purpose built pipe and tube “tee” fittings. In its various embodiments, the insert has features, geometry, dimensions, and material characteristics suitable to the intended application, and is installed into the body through any of a variety of methods including threads, epoxy, press-fit, barbed press fit, plastic welding, solder, O-ring, bushing, flange, clamp, etc. to produce the complete injector/vacuum pump assembly. While the term hydrodynamic ordinarily applies only to liquid fluids, for the purposes of descriptions and claims of the present invention it should also be taken to include gaseous fluids. The injector/vacuum pump insert concept works just as well with gaseous fluids as with liquid fluids.

### FIELD OF THE INVENTION

This invention pertains to pumping, injecting, and mixing, of fluids with devices similar to what are commonly known as venturi injectors. More specifically, the present invention relates to a method for producing an inexpensive fluid injector that creates a vacuum using a cylindrical insert that is installed into a standard or purpose built “tee” fitting, fixture, housing, or other suitable body. While the invention might sometimes take the geometric form of an ideal laminar flow venturi injector, in most embodiments the geometric form would more properly be identified as a turbulent flow cavitation injector.

### BACKGROUND OF THE INVENTION

For over a century, millions of diverse fluid handling applications worldwide have commonly employed venturi injectors. The ordinary “carburetor” found on countless internal combustion engines is a complex form of venturi injector, where the pressure of air passing through a short venturi tube falls in proportion to its increase in speed, thus creating a “vacuum” that “pulls” fuel into the air stream on its way to the combustion cylinders.

A venturi is just a tube with an inlet leading to a constricted throat region, where, as pressurized fluid flows through the tube, fluid velocity increases and pressure decreases. (For this purpose, the term “fluid” refers to both liquids and gasses.) As described by the well-known Bernoulli's principle, as fluid accelerates through the constricted throat of a venturi, pressure falls. When sufficient fluid pressure is applied to the inlet of a properly designed venturi tube, the fluid pressure in the constricted throat region falls to near zero: approaching a vacuum.

A venturi injector is a venturi tube with a small passage through its side leading to the low-pressure region of the venturi throat. Since normal atmospheric pressure at sea level is about 14.7 psi (1013.25 millibars, or 29.92 inches of Hg), venturi injectors can in principle produce a differential pressure between the atmosphere and the venturi tube throat approaching 14.7 pounds per square inch. Hence, atmospheric pressure acting on the surface of liquid fluids, or upon the air itself, will propel fluids connected to the passage leading to the venturi tube throat into the fluid stream passing through the venturi throat. In effect, the venturi injector geometry and fluid flow through the throat serves to convert normal atmospheric pressure into an extremely reliable and inexpensive pump having no moving parts. Pumping, or injection, performance can only degrade or fail if the physical geometry changes, foreign bodies obstruct passages, or fluid flow through the venturi throat diminishes. Durable throat materials maintain constant geometry, and inline filters eliminate foreign body obstructions. Proper design of hydrodynamic systems providing constant fluid pressure to the venturi tube inlet ensures constant flow through the venturi throat.

Prior art ideal venturi injectors work on the laminar flow Bernoulli's principle, with throat inlet/outlet geometry optimized to produce the maximum vacuum in the injection passage for a given inlet pressure and flow rate. Because the ideal geometry of any particular venturi is a complex compound curve that must vary with application, viscosity, inlet pressure, etc., actual geometries of what are often named venturi injectors tend to be a compromise between the ideal laminar flow venturi geometry (if actually known) and what can be most practically fabricated.

Many devices mistakenly called venturi injectors do not actually operate in the ideal smooth laminar flow venturi mode, but rather in a turbulent flow cavitation mode. A more technically correct name for such devices would be hydrodynamic cavitation injectors. Properly designed hydrodynamic cavitation injectors can generally perform nearly as effectively as ideal venturi injectors. Geometry that differs significantly from the ideal laminar flow venturi requires somewhat greater inlet pressure and throat flow, but in most applications both pressure and flow capacity exist in surplus, so this minor limitation poses no particular problem for implementing practical hydrodynamic cavitation injectors.

Cavitation injectors employ an internal geometry that makes an abrupt transition from a restricted throat inlet to a proportionally larger exit passage. Such geometry is simpler, more compact, and easier to fabricate, than the gradually curved cross sectional transition between the inlet and outlet of an ideal venturi injector. Similar fluid flow principles that transform hydrodynamic forces at the injector throat inlet into kinetic energy at the throat outlet, and which generate the differential vacuum pressures near the throat expansion region, apply equally to true laminar flow venturi injectors and to turbulent flow cavitation injectors.

The cavitation injector has much greater internal turbulence. The abrupt increase in throat cross sectional area in the cavitation injector relieves the hydrostatic pressure acting to accelerate the fluid through the throat, produces cavitation between the tube walls and the moving stream of fluid, and allows the fluid stream to expand and slow down. Given sufficient inlet pressure, flow rate, and an outlet region with a cross-sectional area proportionally greater than the restricted throat, the fluid stream exiting the throat will be unable to expand or slow down enough to completely fill the larger exit passage, resulting in a cavitation region of low pressure for some distance beyond the transition point. So, for nearly every practical purpose, the principal operational difference between an ideal, but difficult to fabricate, laminar flow venturi injector and a compromised, but simple to fabricate, turbulent flow cavitation injector is that the ideal venturi operates in a laminar flow mode and will produce a near vacuum with somewhat less mass flow and velocity through the injector throat. In the case of the cavitation injector, as with the ideal venturi injector, atmospheric pressure propels fluids through a passage leading to the low-pressure region of the injector throat and into the cavitating fluid stream passing through the throat. Cavitation injector geometry deviates substantially from ideal laminar flow venturi geometry, so the cavitation injector requires somewhat greater inlet pressure and flow rate to function as effectively as an ideal true venturi.

Hereinafter venturi injectors and cavitation injectors, which both share hydrodynamic forces as the source of operational energy to generate regions of low pressure, will sometimes be referred to simply as “injectors” except where necessary to make a distinction.

Several inherent limitations apply to the practical application of hydrodynamic injectors, including the inventor's special insert types, and should be noted:
a. The maximum possible pressure differential between the throat and injection passage inlet can in principle never exceed ambient pressure. In sea level atmosphere, that is only about 14.7 psi.
b. The fluid to be “pumped” or “injected” into the low-pressure region necessarily mixes with the fluid stream passing through the throat. In many applications, but not all, this is desirable because the intent of the application is to mix two fluids together in specific proportions. This is the case with “carburetors,” where ideally the fuel fluid should be finely atomized and thoroughly mixed with the air stream.
c. Depending on inlet pressure and flow rates, suitable physical geometry for a hydrodynamic injector throat varies from a short transition region to a very gradual change in cross sectional areas upstream and downstream of the narrowest part of the throat. Typical applications, pressures, and flow rates dictate that customary prior art venturi injectors be somewhat asymmetrical and longer on the run side outlet than standard “tee” fittings. Hence, ideal laminar flow venturi injectors in ordinary embodiments are rather bulky compared to standard “tee” fittings.
d. The ideal gradual taper of the discharge side of the ideal venturi throat is difficult to accurately fabricate or machine, particularly in smaller sizes.
e. Any practical hydrodynamic injector must operate with considerable pressure differential between the constricted tube inlet and discharge. Since hydrostatic pressure in the fluid passing through and accelerated in the restricted throat falls to near zero in the throat low pressure region, only the kinetic energy in the fluid stream can maintain any positive fluid pressure in the plumbing connected to the injector discharge. Hence, discharge pressures of hydrodynamic injectors ordinarily cannot exceed 10% of inlet pressures. Hydrodynamic injectors will not inject fluid directly into high-pressure lines.
f. The ratio of injection passage flow rate to throat flow rate is inherently nonlinear. An overly large fluid injection passage allows atmospheric pressure to drive so much fluid into the low-pressure region of the throat that pressure in the throat rises and differential pressure between the throat and injector inlet passage falls.

With injection passage to throat cross sectional area ratios in the range of 1:10 (injection passage 10% of throat cross section), and with throat flow rates high enough to produce 28-29 inches of Hg vacuum, injection passage flow rates tend to be nearly linear. The inventor's empirical testing shows that a cavitation profile hydrodynamic injection tube supplied with an inlet pressure of 150 psi and flowing 25 gallons per hour is sufficient to produce 2.5 gallons per hour of injector passage fluid flow, while maintaining 27 inches of Hg vacuum in the injector passage. Obviously, greater injection passage flow is possible, but then the injector tube throat pressure will rise and there will be less differential pressure to propel the injected fluid.

When a fixed container supplies the fluid to be injected, constant injection rates depend on either constant liquid levels in the supply container or constant differential pressures. Supposing the liquid to be injected has a specific gravity near water, then every inch of change in fluid level in the supply container will change the hydrostatic pressure at the container bottom by 0.0358 psi, or about 0.43 pounds per foot, and the differential pressure at the venturi tube injection port will also change accordingly. Any variations in either the level of the fluid to be injected, or in differential pressures, will produce variations in the injection rate. However, designs that maximize injector throat vacuum minimize non-linearities in injection flow rates, and in many instances reduce them to triviality. Conventional orifice flow rate calculations apply to injection passage flow, so a 10% change in pressure differential produces approximately 3% change in flow rate.

### SUMMARY OF THE INVENTION

The present invention relates to a method of producing hydrodynamic (or gas dynamic) fluid injectors, or vacuum pumps, in which a special cylindrical insert of appropriate material, geometry, and dimensions is fabricated and installed into either a common off-the-shelf or purpose built “tee” fitting, fixture, housing, or other suitable body to produce the complete injector/pump. In many, or perhaps even most, applications, the invention does not actually “work better” than conventional prior art hydrodynamic laminar flow venturi injectors and vacuum pumps, but in many instances, particularly in smaller quantities, it will prove much less expensive to produce. The invention offers a simplified approach to empirical design and testing of hydrodynamic (or gas dynamic) injectors intended for mass production by other more conventional methods, such as plastic injection molding. In addition, merely exchanging one insert for another with a different geometry produces different injector/vacuum pump performance.

### BRIEF DESCRIPTION OF THE DRAWINGS

The accompanying drawings, which are incorporated in and form a part of the specification, illustrate various embodiments of the present invention and, together with the description, serve to explain the principles of the invention. In the drawings:

FIG. 1 shows the general profile of a prior art injection molded ideal venturi injector;

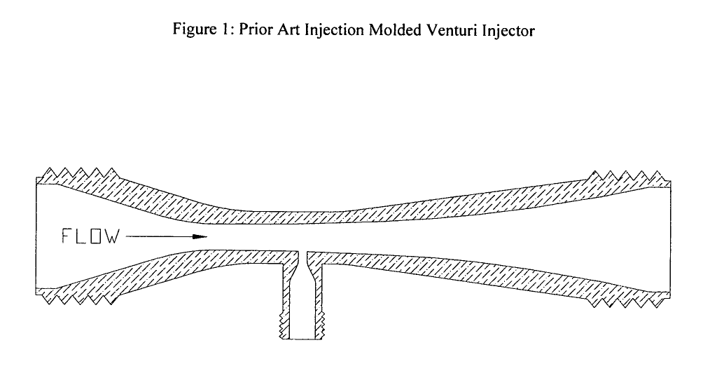

FIG. 2 shows a standard plastic ¼″ tubing “tee” compression fitting;

FIG. 3 shows a cylindrical cavitation injector insert designed to seal with epoxy resin or other suitable adhesive;

FIG. 4 shows a cylindrical cavitation injector insert designed to seal with o-rings;

FIG. 5 shows a non-tapered cylindrical cavitation injector insert designed to seal with O-rings;

FIG. 6 shows a simplified (without drilled injection passage) non-tapered cavitation injector insert designed to seal with integral barbs;

FIG. 7 shows an assembled cavitation injector in cross section, with the cylindrical cavitation injector insert installed into a common plastic ¼″ tubing “tee” fitting;

FIG. 8 shows an assembled non-tapered cavitation injector in cross section, with the cylindrical cavitation injector insert installed into a purpose-built manifold block assembled from custom and common components where the downstream side of the insert communicates with a 90-degree injection passage inside the manifold block;

FIG. 9 shows an assembled simplified (without drilled injection passage) non-tapered cavitation entrainment injector in cross section, with the cylindrical injector insert installed into a common plastic ¼″ tubing “tee” fitting.

### DETAILED DESCRIPTION OF THE INVENTION

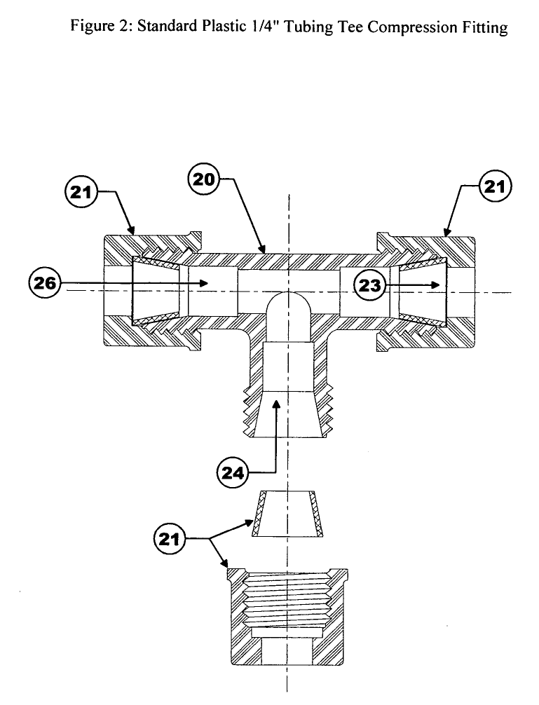

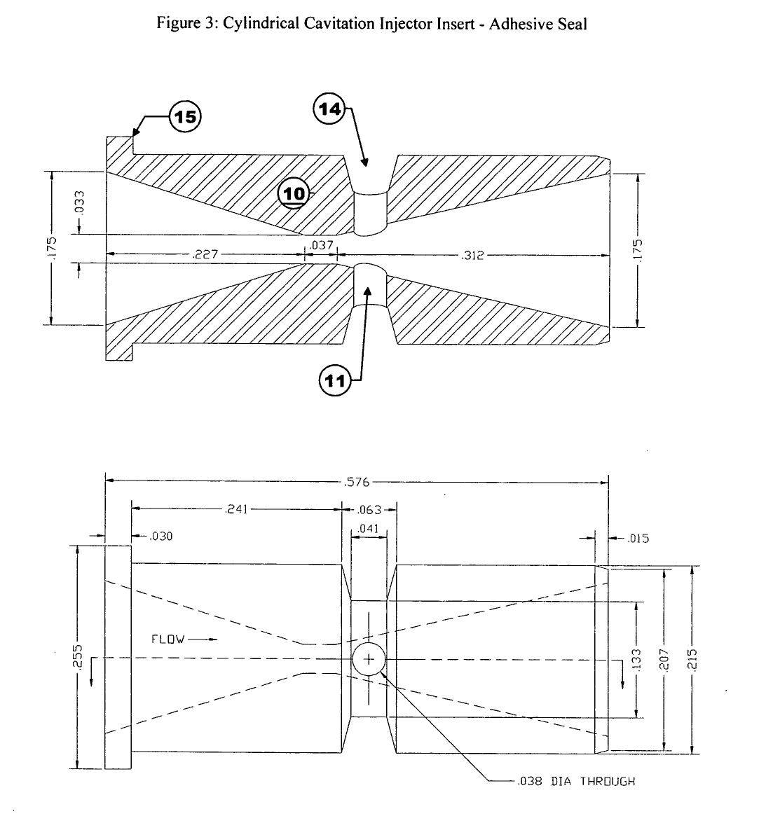

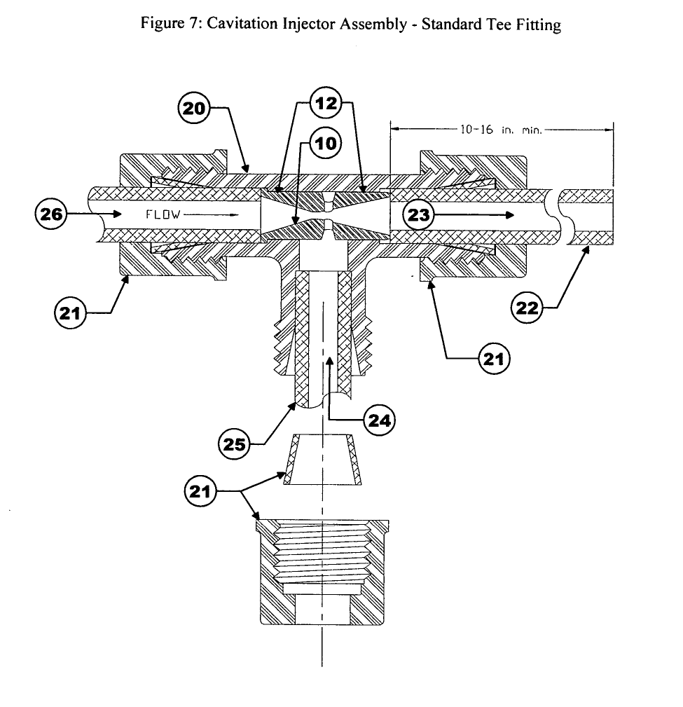

The present invention relates to a method of producing a hydrodynamic (or gas dynamic, hereinafter the term hydrodynamic should be taken to also include gaseous fluids as well as liquid fluids) fluid injector, cavitation fluid injector, or vacuum pump, in which a cylindrical tube of appropriate material, geometry, and dimensions (the insert) 10 (FIGS. 3, 4, 5, 6, 7, 8, 9) is installed into a common off-the-shelf or purpose built “tee” fitting, fixture, housing, or other suitable body (the body) 20 (FIGS. 2, 7, 8, 9). The assembled injector/vacuum pump (FIGS. 7, 8, 9) can then be connected to a manifold supplying inlet pressure and fluid flow needed to produce a predictable throat to injection (suction) passage pressure differential. Modular design of the cylindrical insert hydrodynamic injector/vacuum pump permits easy adaptation for specific fluid viscosity, flow rate, or other variables by replacing one insert 10 with another insert having different geometry and/or dimensions.

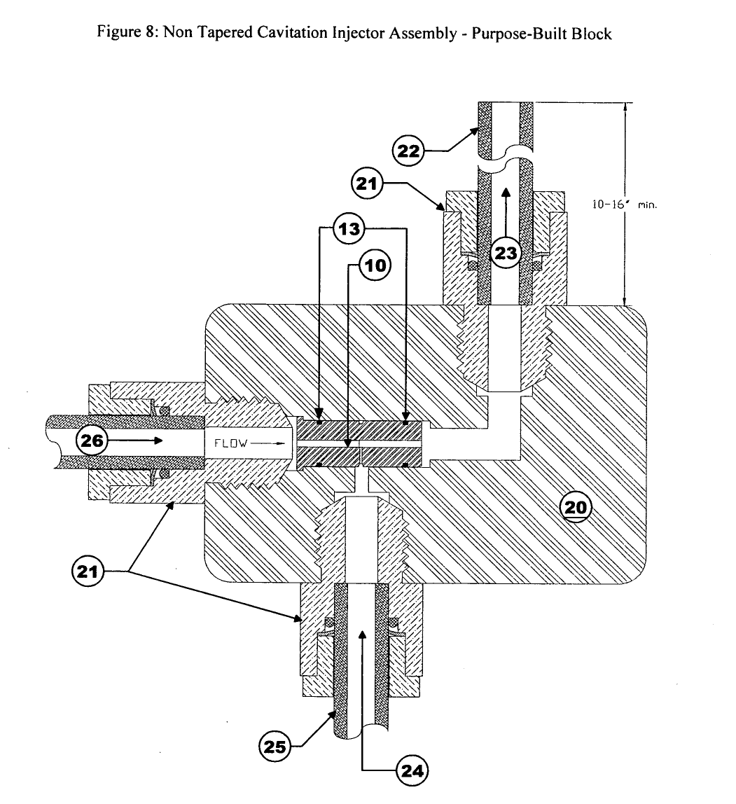

The body 20 of the hydrodynamic injector/vacuum pump can consist of one of any number of common pipe, plumbing, and tubing “tee” fittings available from many suppliers in various sizes and materials including brass, stainless steel, plastic, PVC, etc., and having compression, clamp, flange, National Pipe Thread (NPT), straight thread, push-type, or other connectors/fittings 21 as most suitable for a particular application, where the insert 10 is installed into the run of the body (straight passage through the tee) to produce the complete injector/vacuum pump. The body 20 of the injector/vacuum pump can also be assembled from common components (such as modular push-type connectors) or other fittings 21 that can be threaded, glued, plastic welded, press-fit, or otherwise mated to form a suitable body 20. The body 20 of the injector/vacuum pump can also consist of a purpose-built “tee,” or manifold block, or multi-function assembly where the system design might prove more compact, cost effective, or machining or molding the injection tube geometry integral with the body might otherwise prove difficult or impossible, as in FIG. 8. Two examples of a body are detailed in the attached drawings: one based on a common commercial plastic ¼″ tubing “tee” compression fitting (FIGS. 2, 7, 9) and the other on a purpose-built manifold block with the outlet of the “run” turned 90° from the inlet (FIG. 8). The invention includes a wide range of cylindrical injector inserts and any type of installation of such inserts into a common or purpose built “tee” fitting, fixture, housing, or other suitable body to produce a hydrodynamic injector, entrainment injector, cavitation injector, or vacuum pump.

The examples detailed in the attached drawings are based on cylindrical brass inserts 10 (FIGS. 3, 4, 5, 6) that are mass-produced on screw machines at low cost. The particular materials and methods ideally used to produce the inserts 10 depend on chemical compatibility requirements, the required finished dimensions and tolerances, and the most cost effective methods of producing the required number of inserts. The invention includes other materials for the insert including plastic, stainless steel, ceramic, etc, and it includes various methods of producing the insert such as machining, casting, molding, electro-etching, micro-drilling, laser drilling, etc.

Persons skilled in the prior art of ideal laminar flow venturi injector/vacuum pump design might well examine the geometry of the hydrodynamic injectors/vacuum pumps detailed in the attached drawings and mistakenly conclude the basic designs are unworkable because the throats are not long enough to allow for a gradual expansion of the fluid flowing through the throat. It is true that if no discharge line 22 is connected, and the “tee” fitting discharge 23 communicates directly to the atmosphere, injectors/vacuum pumps of this particular geometry will not “function” effectively. But, because in actual practice the discharge tubing 22 (FIGS. 7, 8, 9) connected to the completed injector/vacuum pump assembly forms, in practical effect, an extension of the throat passage, it is in fact perfectly workable as previously described. Connecting as little as 10-16 inches of ¼″ plastic tubing (0.250 inch OD.; 0.130 inch ID.) 22 to the discharge side of the bodies shown in the drawing examples (FIGS. 7, 8, 9) allows the kinetic energy in the discharge fluid to maintain a solid stream of moving liquid in the discharge tubing, prevent entry of the atmosphere into the throat outlet, and thus raise injection (suction) passage 11 (FIGS. 3, 4, 5) vacuum from near zero to 29 inches of Hg.

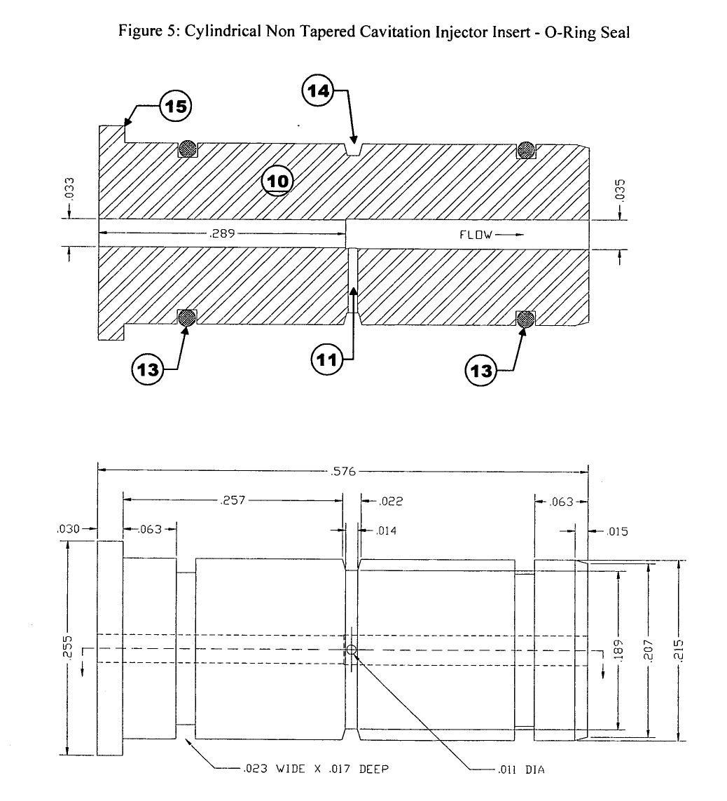

Practical implementation of the cavitation injectors/vacuum pumps detailed in the attached drawings (FIGS. 5, 6, 8, 9) usually depends on somewhat higher throat inlet pressure than ideal laminar flow venturi injector/vacuum pumps require. As injected fluid entrainment occurs within the extended slightly increased (+12%) cross sectional area of the throat of the injector shown in FIGS. 5 and 8, air has no opportunity for entry into the cavitation tube throat outlet. Consequently, without the requirement of a discharge line, the simplified cavitation injector geometry maintains both a near solid fluid outlet stream, and near vacuum in the injection passage. In some applications, where sufficient inlet pressure and flow rate can be maintained, this characteristic coupled with lower cost could make a cavitation injector preferable to a venturi injector.

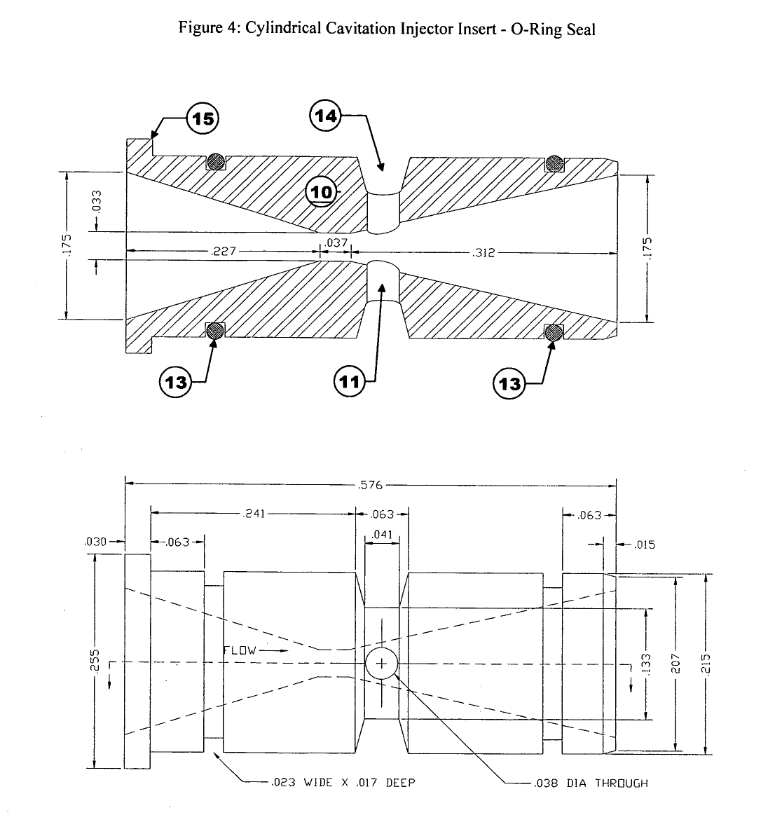

To achieve the desirable maximum pressure differential, leakage must be prevented between the insert 10 and the body 20 of the injector. Hence a seal is needed to prevent leakage. A variety of methods including, but not limited to, threads, solder, epoxy, press-fit, barbs, plastic welding, o-ring, bushing, flange, clamp, etc. can produce the needed seal. Ideal materials and methods used to produce the seal depend on various factors including inlet pressure, surface area, materials, chemical compatibility, dimensional tolerances, etc. The examples detailed in the attached drawings show seals between the insert 10 and the body 20 formed from epoxy resin 12, O-rings 13, and barbs 16 (FIGS. 4, 5, 6, 7, 8, 9).

Creating the hole that forms the injection (suction) passage 11 leading into the lowest pressure zone of the insert throat (FIGS. 3, 4, 5) is a critical aspect of fabricating the injector insert 10. The hole 11 allows fluid in the branch passage 24 of the body (FIGS. 2, 7, 8, 9) to communicate with the lowest pressure region of the injector throat. Depending on application, the injection passage hole 11 can be sized as an orifice to control constant injection flow rates. In many applications where injection rates require changes from time to time, merely changing the insert 10 to one with a smaller or larger injection passage hole 11 would effect the desired change. If some other method is not used to control injection flow rates, then a practical rule of thumb is that the injection passage 11 cross sectional area should be in the range of 10% of the throat cross sectional area.

The injection passage hole 11 in the cylindrical insert 10 should be located at the area of lowest pressure within the tube where the cavitation throat begins to widen on the discharge side. While locating the injection passage hole 11 at an approximation of this location will generally produce good working cavitation injector inserts 10, it should be noted that optimum location and size for the injector passage hole depends on hole diameter, throat inlet pressure, flow rates, fluids to be employed, throat length, etc. Hence, optimum location and size for the injector passage hole will vary somewhat, and best practice is to conduct empirical tests before mass production.

In concept, good fabrication practice would produce a girdling groove 14 on the circumference of the cylindrical insert 10 located nearest the region of lowest pressure within the injector throat passage (FIGS. 3, 4, 5). The groove, while not essential for effective injector operation, indicates the ideal location for drilling the injection passage hole 11 and provides a path around the circumference of the insert for the fluid in the branch passage 24 of the body 20 to communicate with the injection passage hole 11 leading to the throat passage. Ideally, the girdling groove 13 should be proportionally wider and deeper than the injection passage hole diameter to create an unrestricted path for fluid to travel from the branch passage of the body to the injection passage hole. The girdling groove eliminates all need for careful alignment of the injection passage hole with the branch passage when the insert is installed into the body. If desired, the injection passage hole can pass completely through the insert, thus doubling the injection passage cross sectional area and producing symmetrical injection from two opposing sides of the throat passage.

In the cavitation injector insert drawing example (FIGS. 3, 4), the injection passage hole 11 is 0.038″ in diameter drilled completely through both sides of the cavitation tube 10 slightly downstream from the narrowest region of the throat, and the throat constriction is 0.033″ in diameter. This results in an injection passage to throat cross sectional area ratio of approximately 26:10 (injector passage 260% of throat cross section). The relatively large diameter of the 0.038″ injection passage holes in the example cavitation injector drawing, which departs dramatically from the suggested 10% of throat cross section rule of thumb previously suggested, was selected as a practical fabrication consideration to avoid breaking micro-drill bits when drilling a 0.011″ hole that the 10% rule would require. The oversized injection passage hole requires that some means other than hole diameter be used to restrict injection flow rates. In the actual application of the drawing example, a 0.0177″ diameter inline orifice (not shown), combined with an adjustable cycle solenoid valve (not shown), restricts fluid flow in the fluid supply line 25 leading to the branch passage of the body (suction port) 24, and produces an effective injection passage to throat cross sectional area ratio of approximately 2.9:10 (effective injector passage 29% of throat cross section). Empirical evaluation of an actual insert fabricated according to the drawing example (FIG. 3) shows that a 0.0177″ inline orifice produces sufficient flow restriction in the injection passage line to prevent either a significant rise in throat outlet pressure, or loss of suction port passage vacuum when tested as described next:
150 PSI water pressure at the injector inlet 26 of the design detailed in the attached drawing (FIG. 7) produces 25 gallons per hour throat flow at the injector discharge 23, and produces 28.5 to 29 inches of Hg vacuum at the suction port 24. With a 0.0177-inch inline orifice restricting suction port flow rates to 10% of throat flow (2.5 gallons per hour/25 gallons per hour), suction port vacuum only falls to 27 inches of Hg.

In the non tapered cavitation injector insert drawing example (FIG. 5), the injection passage hole 11 is 0.011″ in diameter drilled through one side of the injector insert 10 slightly downstream from the transition to the larger diameter of the throat. The injector throat constriction is 0.033″ in diameter. This results in an injection passage to injector throat cross sectional area ratio of approximately 1:10 (injector passage 10% of throat cross section).

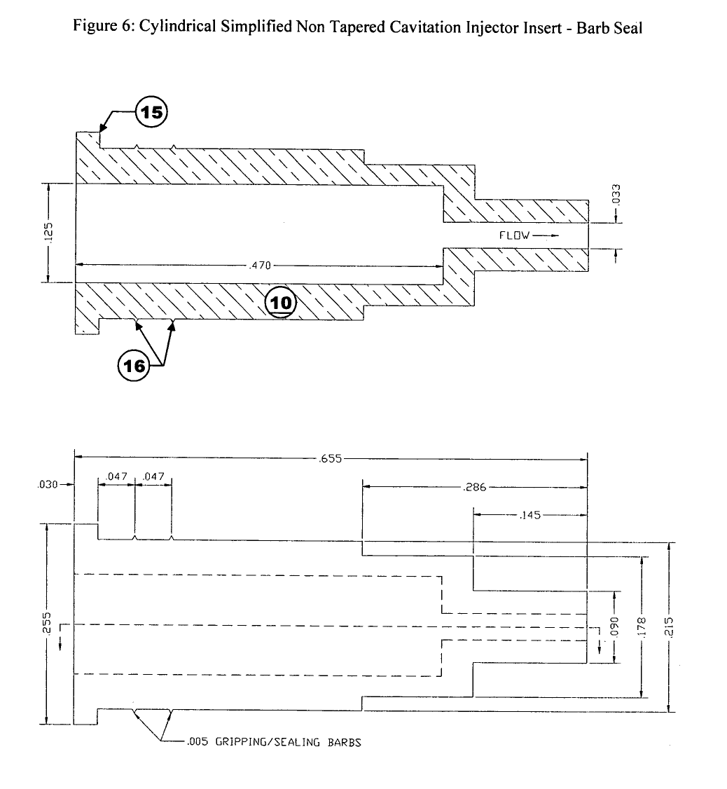

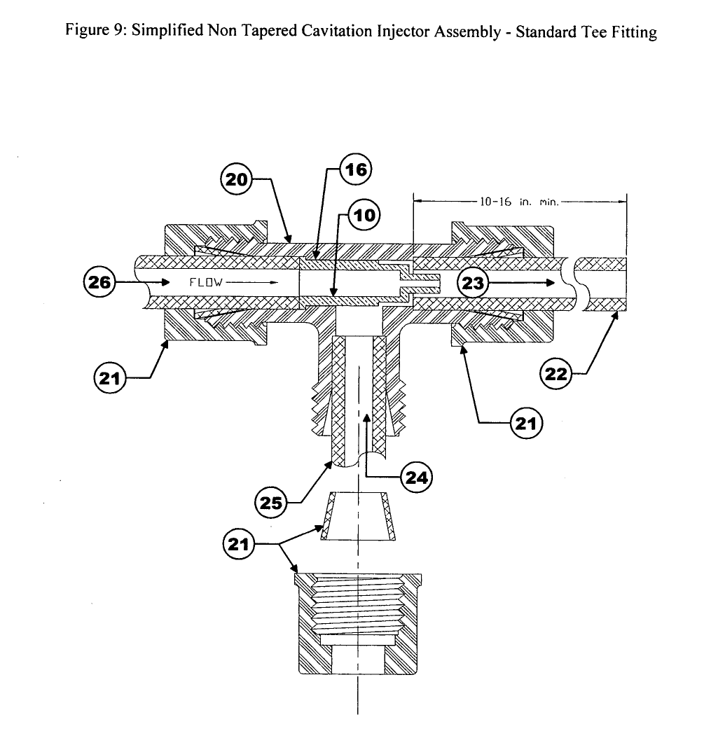

The simplified non-tapered cavitation injector insert detailed in the attached drawings (FIGS. 6, and 9) is a design that eliminates the need to drill an injection passage hole in the insert. In practical effect, the injection passage hole is replaced by the annular space between the reduced outside diameter of the injector insert outlet and the inner diameter of the connected discharge tubing. As injected fluid passes from the insert outlet into the connected discharge tubing, cavitation occurs within the discharge tubing; pressure falls, and ambient pressure propels fluid from the injection port through the annular space into the fluid stream exiting from the cavitation insert. Somewhat greater inlet pressure and flow rate may be required for this design to work effectively.

The particular features, geometry, and dimensions of the example cylindrical cavitation insert 10 detailed in the attached drawings (FIGS. 3, 4) are for illustration only; specific features, geometry, and dimensions should vary according to the particular application. For example, the ideal specific taper angles of the inlet and outlet areas of the cavitation tube depend on several factors such as material, production method, fluids to be employed, inlet and outlet pressures, flow rates, etc. Optimum inlet/outlet taper angles for a given application might vary considerably from the drawing example, and might have no taper at all, as shown in the example non tapered cylindrical cavitation injector insert drawing (FIG. 5). For some applications the non-tapered simplified cylindrical cavitation injector insert, as shown in FIG. 6, with no injection passage hole, might serve as effectively as an ideal gradual transition venturi injector.

Standard fluid kinetics texts well cover design practice for ideal laminar flow venturi tubes/injectors, and need not be reiterated here. Design methods for the inventor's cavitation injectors, however, are not found in the domain of prior art. A simplified step-by-step description of the inventor's method for designing hydrodynamic cavitation injectors with drilled injector passage holes follows:
1. Determine the desired flow rate of fluid to be injected.
2. Use standard orifice calculations to determine injection passage diameter/cross sectional area so that 14-psi pressure differential will produce the needed flow rate of injected fluid.
3. Injector tube throat cross section area should be in the range of 5-10 times the injector passage cross section area calculated in the previous step. Simply square the injection passage diameter and multiply by 5-10. The square root of that product equals injector tube throat diameter. Dᵢₜ=(Dᵢₚ²×10)^{1/2} (Keep in mind, to maintain 27″ Hg vacuum during injection, the throat mass flow must be in the range of 10 times injection mass flow.)
4. Select standard “off the shelf” “tee” fittings with internal diameters at least 5-10 times larger than insert throat diameter. The standard fittings selected must be suitable for mating with a cylindrical cavitation injector insert.
5. Accurately measure the internal diameter and length of the “run” passage through the “tee.”
6. Machine the cylindrical injector insert OD to mate with and fit snuggly within the stock tee ID. Drill the cylindrical insert inlet passage 0-500% larger than the throat diameter. Drill the insert throat diameter to the dimension calculated in step 3 above, and to a depth so that when the insert is installed in the tee, the throat passage terminates in the half of the “tee” branch nearest the insert inlet so that the injector passage hole can be drilled downstream of the throat and communicate with the “tee” branch.
7. Drill the insert discharge passage diameter 5%-10% larger than the throat diameter.
8. Drill the insert injection passage hole slightly downstream of the injector throat. Only empirical testing can precisely optimize the injection passage hole location.
9. Install the prototype insert in the stock tee and run empirical performance tests of throat flow, injector passage flow, and vacuum levels. Because cavitation injector performance sometimes depends to some degree on piping or tubing connected to the outlet as an extension of the discharge side of the throat, discharge tubing length and ID for optimum effectiveness should be evaluated during injector testing.

The cavitation injector inserts shown in the attached drawing examples have seven essential features:
1. Each end of the insert 10 is of a suitable outer diameter to allow the insert 10 to form a seal 12, 13, and 16 against the inner diameter of a suitable body 20. (This feature applies only to the inlet/flange end of the simplified cavitation injector shown in FIGS. 6 and 9); and
2. the overall length of the insert 10 allows the insert to span the width of the run of the “tee” fitting, and is short enough to avoid interference with attached fittings 21 and tubing 22 at the “tee” discharge outlet 23; and
3. the inlet end of the insert 10 has a positioning flange 15 to seat against a boss that exists inside the example body 20; and
4. a constricted throat passage through the insert; and
5. one or more changes in throat passage cross-sectional area designed to produce the desired hydrodynamic pressure differential, and which may be formed as gradual tapers or abrupt transitions; and
6. an injection passage hole positioned near the outlet end of the constricted throat passage at the point of lowest pressure (This feature does not apply to the simplified (no injection passage hole) cavitation injector shown in FIGS. 6 and 9), and
7. the midsection of the insert 10 has a reduced diameter girdle 14 of a width proportionally wider than the injection passage hole 11 to provide a path for the injection passage hole to communicate with the branch suction port 24, and to indicate the location for drilling the injection passage hole along the length of the venturi tube throat at the area of lowest pressure. (This feature does not apply to the simplified cavitation injector shown in FIGS. 6 and 9.)

Although the present invention and its advantages have been described in detail, it should be understood that various changes, substitutions, and alterations could be made herein without departing from the spirit and scope of the invention as defined by the appended claims.

What is claimed is:

I. The concept, design, and application of a modular hydrodynamic cavitation injector insert, or hydrodynamic vacuum pump insert, or venturi injector insert, comprising:
a cylindrical insert having internal and external features, geometry, dimensions, and material characteristics to produce a cavitation injector, vacuum pump, venturi injector, or similar device when combined with a suitable body and related hardware.

II. The concept, design, and method of producing a hydrodynamic cavitation injector, hydrodynamic vacuum pump, venturi injector, or similar device comprising:
the cylindrical insert from claim 1; and
a body composed of a common off-the-shelf pipe or tubing “tee” fitting, or an assembly of common off-the-shelf pipe or tubing components connecting the inlet, outlet, and injection passages of the insert to fluids of suitable pressure, viscosity, and flow rate; and
a suitable seal between the insert and the fitting body to prevent fluid and/or pressure leakage between the insert and the body.

III. The concept, design, and method of producing a hydrodynamic cavitation injector, hydrodynamic vacuum pump, or venturi injector, or similar device comprising:
the cylindrical insert from claim 1; and
a body composed of a purpose-built “tee,” or manifold assembly, or an assembly combining valves, regulators, timers, or other devices as part of a multi-function body assembly; and
a suitable seal between the insert and the body to prevent fluid and/or pressure leakage between the insert and the body.
